(19) United States
(12) Patent Application Publication
(10) Pub. No.: US 2004/0095244 A1
(43) Pub. Date: May 20, 2004

(54) Tire identification label and tire label film with integrated barrier

(76) Inventors: Kevin Conwell, Fairfield, OH (US); Thomas Rogers, Fairfield, OH (US); Karen Perry, Cincinnati, OH (US); Patrick Bush, West Bloomfield, MI (US)

Correspondence Address: ORUM & ROTH, 53 W. JACKSON BLVD, CHICAGO, IL, 60604, US

(21) Appl. No.: 10/623,393

(22) Filed: Jul. 18, 2003

Related U.S. Application Data
(63) Continuation-in-part of application No. 10/391,036, filed on Mar. 18, 2003.
(60) Provisional application No. 60/379,965, filed on May 10, 2002.
(60) Provisional application No. 60/397,207, filed on Jul. 19, 2002.

(51) Int. Cl. B60C 13/00; B32B 33/00

(52) U.S. Cl. 340/572.8; 152/524; 428/354; 156/90; 428/334; 340/572.1; 156/110.1

(57) ABSTRACT

A tire label with an integral barrier layer. The barrier layer is formed of polyester film and is 3 to 15 microns thick. The barrier layer may be for example PET. The label may be formed on printable plastic film stock preferably coated with a thickness of between 0.001 to 0.004 inches of a pressure sensitive rubber based adhesive. The adhesive may be applied in a pattern on the film stock leaving a pull-tab to allow easy removal of the label. When adhered to a tire sidewall the label is oriented with the pull-tab in the tread direction so that the tire mounting and testing procedures do not snare it. Machine-readable data can be printed on the label in a machine-readable 2D data matrix symbology alongside a human readable ascii serial number. The label can also have an integral RFID tag.

This application is a continuation in part of U.S. application Ser. No. 10/391,036 “Tire Identification Label” filed Mar. 18, 2003 that claimed the benefit of U.S. Provisional Application 60/379,965 filed May 10, 2002.

This application also claims the benefit of U.S. Provisional Patent Application “Tire Label Film with Integrated Barrier” filed Jul. 19, 2002, serial No. 60/397,207, hereby incorporated by reference in the entirety.

### BACKGROUND OF THE INVENTION

1. Field of the Invention

The present invention relates to machine-readable labels for tire identification and tracking. More specifically, this invention relates to tire label film with integrated barrier for use with a two-dimensional bar code symbol.

2. Description of Related Art

In 2000 the National Highway Traffic Safety Administration (NHSTA) pressured automobile manufacturers to recall thousands of tires because of tread separation. Suspect lots were traced back through the tire manufacturer's quality records, but no records existed in the vehicle chassis assembly process to link tire serial numbers to the vehicle identification number (VIN). Legislation passed by Congress and the Department of Transportation now requires automobile manufacturers to implement a tracking system to link the tire serial numbers and VIN. Further, tire and automobile manufacturers are being pressured to implement a more reliable and accurate method of tracking the DOT code, tire serial numbers, size, type, conicity, date, manufacturing plant, even the mold machine for every tire, and to tie this information to the VIN.

The recent tire recalls were much wider than necessary because no data existed as to which tire lots and/or tire manufacturing dates had been installed on specific vehicles. Therefore a need exists for a cost-effective tire identification system usable from the time of tire manufacture until the tire is matched and mounted to a specific vehicle so that the tire serial numbers may be associated with a VIN in the vehicle manufacturer's database.

Historically, tire manufacturers relied on hand stamping tires with lot and date codes using indelible ink or the use of “bumpy bar codes”, i.e., raised bar code symbols directly embossed or molded into the surface of a tire to track and identify tires. The low data density of these systems prevent them from incorporating the required data storage volume and the molding technology required increases tire manufacturing costs while providing limited flexibility for incorporating on-demand variable data. Other technologies providing high-density machine readable data include U.S. Pat. No. 4,991,217 which discloses a passive radio frequency identification transponder tag which may be interrogated by a radio frequency field from outside of the tire. This solution is presently prohibitively expensive and is susceptible to radio wave interference and damage from vulcanization heat/pressure during the tire manufacturing/tag mounting process. U.S. Pat. No. 5,160,383 discloses a tire label permanently mounted to an inner liner of the tire for tracking of tire serial numbers throughout the entire life of the tire up to and including retreading of the tire. The label is manufactured using a SPBD/rubber blend which is permanently affixed to the inside of the tire where it is cured along with the tire in a mold by the heat and pressure of the vulcanization curing process. Mounted on the inside of the tire, the label is only readable when the tire casing has been removed from the tire rim. U.S. Pat. No. 4,010,354 discloses a magnetically encodable tag in a sequential tape format that is encoded with tire identifying data which is applied to the side wall material of a green tire. The magnetically encoded tape and associated encoding and decoding equipment increases the tire costs when compared to the present invention. Several other technologies exist for tire identification and tracking.

The use of magnetically encodable tags in tape format written sequentially with tire identifying data and applied to the sidewall material of a green tire is described in U.S. Pat. No. 4,010,354. The encoded data may be read from the tire at any point in the tire manufacturing process and the signals indicative of the tire identification number converted to an alphanumeric display and/or fed to a process control computer for on-line quality assurance and control or stored as a recorded history of the tire manufacturing process for inventory control.

The use of a resin based film type substrate used for a tire production control label is described in U.S. Pat. No. 5,709,918. The label surface is printed with a bar code and a pressure sensitive adhesive layer is formed via a primer layer on the back side of the label surface. The printing does not become blurred or erased under the high temperatures and high pressures during vulcanization.

An apparatus and method for supplying a graphic label that is readable with a light scanning device when the label placed on a rubber article such as a tire is described in U.S. Pat. No. 5,527,407. The graphic bar code label is optically interpreted by a bar code reader. Printing is applied using thermal transfer techniques.

A label is designed to be disposed on an unvulcanized raw rubber tire and then fixed to the finished tire by vulcanization using heat and pressure is described in U.S. Pat. No. 5,358,772. The indication label having a label base material with a heat-resistant plastic film and an abrasive surface coating layer formed on the upper surface of the plastic film. The abrasive surface being composed of a hardened resin and filler. An indication defined by an ink layer is disposed on the abrasive surface. A rubber adhesive laminated on the lower surface of the plastic film adheres the label to the tire. The label is constructed by forming the ink layer on the exterior side of the abrasive surface coating layer. The abrasive surface having a profile and roughness for preserving the quality of the indication.

The use of a multilayer adhesive construction and method for production of a label face stock that includes an adhesive barrier layer on the back of the label face stock, and an adhesive layer on the barrier layer is described in U.S. Pat. No. 5,993,961. The adhesive barrier layer comprises a pressure-sensitive adhesive which inhibits the migration of mobile species such as oils, resins, tackifiers, or plasticizers from the adhesive layer into the facestock or from the facestock into the adhesive layer. This migration of mobile ingredients often manifests itself as swelling or hardening of the facestock which, in turn, leads to wrinkling of the adhesive construction and general loss of adhesion. The multilayer adhesive construction of the invention thus improves adhesion and the appearance of the label by inhibiting wrinkling and/or staining.

A composite construction for use as a label or a tape to be adhered to a second substrate comprising a rubber-based material such as a tire is described in U.S. Pat. No. 6,235,363. The label face stock made of paper, polymer film or combination contains a barrier layer adhered to the underside between the label and adhesive. This barrier layer is a radiation cured cross linked cycloaliphatic epoxide derived from at least one cycloaliphatic epoxy compound, at least one polyol and at least one photoinitiator, said barrier layer being substantially impervious to migratory components in said adhesive layer and rubber tire components.

The Automotive Industry Action Group (AIAG) recently published a B-11 guideline entitled “Tire and Wheel Identification Standard” which recommends a tire tracking system using a label printed with a two-dimensional bar code symbol. These labels would be applied on OEM production tires and later removed after final wheel and chassis assembly.

Current label designs for labeling tires use conformable films such as biaxially oriented polypropylene (BOPP) or polyolefins (blends of polypropylene and polyethylene) for the label face stock. These films conform well to a tire surface, but as the tire ages there are components within the rubber compounds that bleed and migrate to the surface and interact with the label film. Migration is also a problem for tires exposed to elevated temperatures, for example within a trailer during storage/transportation during summer months. This migration of waxes, oils, lubricants, plasticizers and other low molecular weight additives into the label adhesive and label film not only discolors the label but also impacts the adhesive bond of the label film, making it weaker and likely to lift or flag.

The inventive label incorporates a barrier layer designed to resist any discoloration caused by the migration of multiple species within the tire and adhesive into the label face stock.

It is critical that the label maintain a high brightness to provide high symbol contrast for scanning. Current two-dimensional barcode labels on the market suffer from staining and discoloration which results in a lack of brightness. This staining and discoloration can be caused both by migration of mobile species such as oils, lubricants and plasticizers from within the tire to the label face and from migration of mobile species such as resins, tackifiers and plasticizers from within the rubber based adhesive to the label face.

A currently available label film with a prior art barrier layer was tested on tires for use as a 2D bar code label. Aging tests indicate the the film with a barrier layer on the underside does not prevent staining or discoloration. The TAPPI T452 brightness level for tested label film dropped from 86 to 28 whereas the inventive polyester label film maintained a brightness level of 86.

For bar code applications it is critical that the label face maintains a high brightness level to provide high symbol contrast for scanning. It is an object of the present invention to prevent staining and discoloration caused by the migration of mobile species from within the tire into label face. It is also an object of the present invention to prevent staining and discoloration caused by migration of mobile species from within the adhesive into the label face.

Current bar code labels on the market suffer from a failure of the adhesive bond between the adhesive and the back of the label. Decreased adhesion between the label and the rubber adhesive is caused by migration of aluminum, sulfur, carbon black fillers, waxes, lubricants, plasticizers, oils and other low molecular weight components into the label. There is a need for labels without adhesive degradation. It is an object of the present invention to prevent the degradation of the adhesive bond between the tire and the label to prevent lift off or flagging of the label over time.

From a commercial standpoint, it is very important for the tire tracking system to be inexpensive yet reliable and effective. The use of a self-adhesive printed label provides a good solution. Customers can use a thermal transfer printer to print on-demand labels with a two-dimensional bar code in the manufacturing environment. The bar code allows for fast, reliable, accurate data collection without human error or replication. The pressure sensitive adhesive provides a simple means of affixing the label to the outside sidewall of any tire without being labor intensive. Placement of the label on the outside of the tire allows for instant bar code scanning and data collection from the point where it is manufactured all the way through to the final wheel/chassis assembly process.

A barcode label has distinct cost advantages over RFID systems. Further, two-dimensional bar code label has increased data storage compared to linear bumpy bar code embossing. It also offers flexibility and on-demand printing of data and lot code information within the manufacturing environment compared to pre-molded, pre-fabricated, preprinted identification systems.

The inventive label with a barrier coatings is also suited for use with an RFID label, where migration of mobile species can damage the RFID by compromising the bond between the integrated chip and base, and/or between the antenna and the chip.

### SUMMARY OF THE INVENTION

This invention uses composite construction of a label or tape with an integrated barrier to be adhered to a rubber surface, such as a tire. The label incorporates a barrier layer designed to resist staining and discoloration caused by migration of mobile species such as oils, waxes, resins, tackifiers, lubricants, and plasticizers from within the tire and/or adhesive into the label face stock.

A thick label is necessary to help reduce a heavy coat weight of adhesive from bleeding out around the edges of die cut labels. If the adhesive bleeds out, the labels can stick and jam when carried through a printer.

A 2-3 mil thick polyester (such as PET) label stock with no separate barrier coating on the back side will resist staining/discoloration and maintain a strong, stable bond to a rubber hot melt pressure sensitive adhesive when applied to a tire surface. While a thick, but conformable label is desirable, polyester is expensive for label material.

The label can be constructed to prevent migratory corruption via low molecular weight component migration by replacing the thick polyester label with a thin gage polyester barrier film layer 3-15 microns thick, laminated to the back side of a thick conformable polyolefin or polypropylene film. The composite film will reduce the cost and still provide resistance to staining. A barrier layer of a continuous solid PET film is more effective at blocking migration than other known coatings, such as an epoxy coating. Less expensive label face stock can then be used for the label.

With labels made of polypropylene or polyolefin, low molecular weight components from an automobile tire will diffuse through a pressure sensitive adhesive and into a label stock film as the tire ages. Tires typically contain many such species. One such component is plasticized sulfur and hydrogen sulfide. Plasticized sulfur is a common ingredient in tires for maintaining a flexible, elastomeric product after vulcanization. Another component is oil. The combination of tetrabenzylthiuram disulfide, cashew nut oil modified novolak-type phenolic resin, a bismaleimide compound and a sulfonamide compound provides for excellent vulcanization of rubbers and results in desirable final rubber vulcanizate physical properties in the absence of generating undesirable nitrosamines and fumes during processing and cure. Compounds comprising an elastomer and a phenolic resin which has been cured with 1-aza-5-methylol-3, 7-dioxabicyclo(3,3,0)-octane (AMDO) are commonly used in tires. The phenolic resin is an oil modified phenol-formaldehyde 2-stage resin.

Vulcanized rubber compounds also contain combinations of an anti-reversion coagents and sulfide resins to improve the physical and mechanical properties such as tensile strength, heat resistance, dynamic properties, and rolling resistance. Certain modifying agents and particulate fillers such as carbon black, and sulfur cross-linking agents dispersed into sulfur crosslinkable hydrocarbon elastomer are used in tires. The particulate filler, sulfur crosslinking agent, and extender oil is added to the elastomer subsequent to addition and substantial dispersion of the filler and sulfur crosslinking agent into the elastomer in an early stage of the multi-stage tire-manufacturing process to improve the overall performance of the tire.

Anti-migration and anti-ozone protective coatings can be applied to the external surface of tires comprised of a homopolymer or copolymer based on at least one monomer chosen from the group of acrylic, methacrylic and vinyl esters and a constituent chosen from the group consisting of a hydrophilic silica and a homopolymer or copolymer based on at least one monomer chosen from the group of acrylic, methacrylic and vinyl monomers, said homopolymer or copolymer. Further, tires may have rubber composition with a base of precipitated silicas doped with aluminum. Aluminum in the silica filler counteracts the tendency for silica/silica interactions, producing agglomerates. The aluminum is present on the outer layers of the silica matrix and/or the surface of the tire. These materials can migrate from the tire into the label causing staining, discoloration, wrinkling, flagging, and/or degradation of the adhesive bond.

Typical base films such as polypropylene or polyolefin, are not impermeable to migratory components such as those described above. Thus, over time migratory species such as aluminum, sulfur, and carbon black fillers can migrate or diffuse into the label along with plasticizers, oils, and other low molecular weight components resulting in staining, discoloration, and decreased adhesion between the label and rubber adhesive. This diffusion process can be influenced by several factors including ambient temperature, humidity, concentration of filler contaminants in the rubber tire compound, the chemical nature of the label face stock, the chemical nature of the pressure sensitive adhesive, the thickness of the label face stock, and the thickness of the adhesive. Higher ambient temperature and humidity levels typically accelerate the diffusion process.

It is desired to have a label construction that restricts or prevents this diffusion process. The label has an integrated barrier, to prevent staining, discoloration of the face sheet and degradation of the adhesive bond, which restricts the migration of migratory species.

A label with a barrier film construction can also be used as a means of protecting an RFID tag (base, antenna, integrated circuit chip) from migratory components when attached to a tire surface or other rubber surface. Diffusion of these migratory components to the tire surface may impact the bond of the RFID tag to the rubber tire or interfere with the bonds between the RFID tag elements. This could occur when the RF tag support or base substrate is not impermeable to migratory components (for example, a base film constructed of polypropylene or polyolefin). As a result, bonds in the RFID tag could be compromised, including the bond between the antenna and base, the bond between the integrated circuit chip and the base, and the bond between the antenna and the integrated circuit chip.

The migration of corrosive or bond degrading components will be significantly reduced or eliminated by the addition of a barrier layer between the rubber surface and the RDIF tag.

### BRIEF DESCRIPTION OF THE DRAWINGS

FIG. 1 is a cross-section of a tire label film with integrated barrier.

FIG. 2 is a cross-section of a tire label film with integrated barrier for use with an RFID tag.

FIG. 3 is a front view of a blank label showing the preferred label corner radius dimensions.

FIG. 4 is a back view of the label from FIG. 1 showing the adhesive and dry pull tab areas thereon.

FIG. 5 is a diagram showing the label layout upon a bulk media roll.

FIG. 6 is a front view of a sample label printed with data.

### DETAILED DESCRIPTION

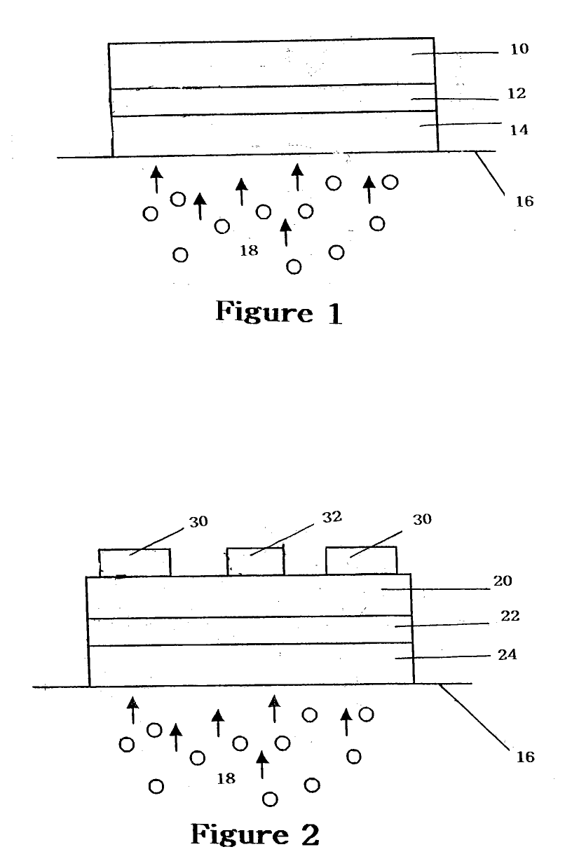

FIG. 1 shows a cross-section of a tire label film with an integrated barrier. The label has a layered construction and comprises a printable label face 10. Label face 10 is a preferably a conformable film such as biaxially orientated polypropylene (BOPP) or polyolefins (polypropylene, polyethylene, polymers of ethylene-propylene diene monomers (EPDM), copolymers, or blends). These films are preferred because they conform well to the tire surface. However, other known films may be used for the label face. Laminated to the underside of the label face 10 is a barrier layer 12. Beneath the barrier layer is an adhesive layer. Preferably, the adhesive is a pressure sensitive rubber adhesive.

The label face stock is required to be sturdy enough to withstand the tire manufacturing and assembly environment including warehouse storage, handling, shipping, trailers, conveyors, soaping, wheel mounting equipment, inflation, balancing, and load simulator operations and equipment. Because tire mounting machines and load simulation equipment actually contact the tire side wall and thus the label, the label is subject to severe stress. The label face stock should be able to resist tearing, abrasion, staining, grease, oil, heat, moisture, plasticizers, and UVB exposure. Therefore, label face stock may be between 0.001 inches and 0.008 inches thick formed out of, for example; a polyester label film, polyethylene napthalate, polypropylene, polyurethane, polyethylene, polystyrene, polycarbonate, polyolefin, polyamide, acetate, acrylic, acrylar, vinyl, polyvinyl fluoride, Tedlar, Tyvek, Teflon, and/or synthetic paper. A film stiffness of the label face stock should be between 20 and 80 mg (Gurley). This will allow good dispensing properties for self-stripping the label from the release liner on a label-dispensing unit, yet be flexible enough to conform to the curvature of a tire sidewall. The label face stock should have lay-flat properties to reduce label creasing and wrinkling and to prevent the dry-pull tab from lifting or folding back over the bar code symbol.

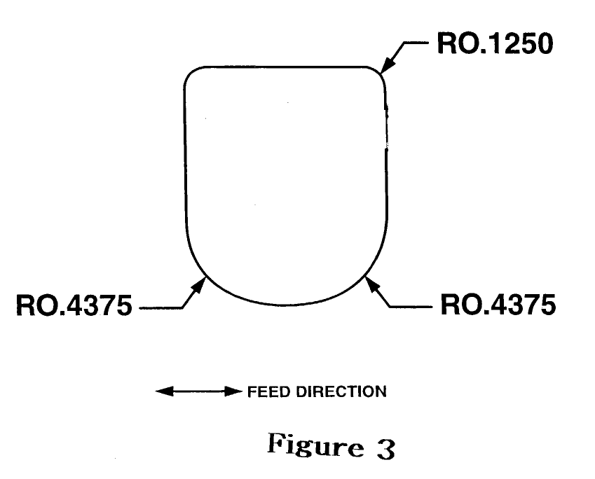

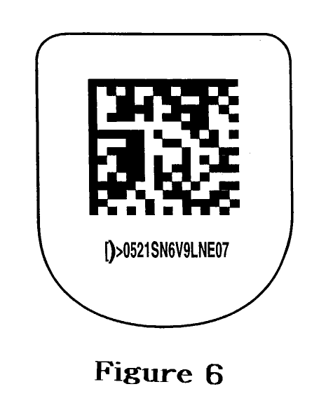

Configuring the label 1 as shown in FIG. 3 allows sufficient printable area to place a 2D machine-readable symbology and an ascii serial number thereon as shown in FIG. 6. Preferably, the label 1 dimensions are selected to be small enough so that the label 1 will fit onto a smooth space available on the sidewall of any size/brand of tire. The selected radiuses resist rollover of the label face stock while the label is adhered to the tire sidewall.

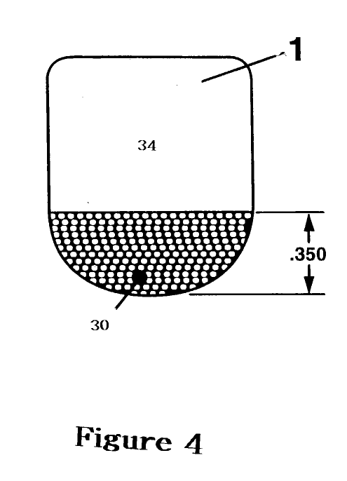

As shown in FIG. 4, the label may be configured with an adhesive area 34 and a dry-pull tab area 30. The dry-pull tab area 30 allows for easy removal of the label 1 once the tire has been mounted onto a vehicle and the data thereon scanned and assigned to the VIN database for that vehicle. Orienting the label 1 with the dry-pull tab pointing either at the tread or at the center of the tire allows the label to be subjected to increased sideways shear from the tire mounting, tire inflation and/or load simulation equipment which may be contacting the tire side wall.

For removeable labels, label adhesive is preferably a pressure sensitive rubber based adhesive coated in a thickness of between 0.001 and 0.004 inches. The adhesive bond should be strong between the label and the tire sidewall, yet removable after the final wheel/vehicle carriage assembly.

A barrier coating may also be used between the adhesive and label to prevent plasticizer migration into the label which may weaken the label/adhesive bond and/or discolor the label face.

To prevent diffusion of mobile low molecular weight components into the barrier layer 12 must be designed to meet one or both of the following conditions:

A. The barrier layer 12 is comprised of a material that is dissimilar to the migratory species 18 in terms of polarity. Since diffusion is promoted with materials of like chemistry, a dissimilar material will inhibit diffusion. For example non-polar material, such as oil, will not diffuse well through a polar film such as polyester or PET film.

B. The barrier layer 12 is comprised of a polymeric material that has film structure such that migration of low molecular weight materials 18 is restricted. A highly branched polymer, such as PET, will prevent component migration due to size exclusion. A low-branched polymer has free spaces between its bonds which allow low molecular weight materials to pass between the bonds. A high-branched polymer, such as PET, has tight bonds and restricts low molecular weight materials from passing between the bonds.

In the preferred embodiment, the barrier layer 12 is made of a thin gage polyester barrier film. Preferably, the barrier layer is from between about 3 to about 15 microns thick.

The label face 10, barrier layer 12, and pressure sensitive adhesive 14 are suitable for thermal transfer printing with a two dimensional bar code in the manufacturing environment. Other printing techniques suitable for printing labels may be used. The label is then applied to the tire surface 16. The adhesive 14 provides the means for fixing the labels to the sidewall of any tire 16. It should be understood that use of a label of the present invention is not limited to tires 16 and such a label would be suitable for use with other items, particularly with other rubber based items.

Within the tire 16 there are a variety of migratory species 18. These migratory species 18 can migrate through the tire 16 and the adhesive 14. The barrier film 12 impedes migration of these migratory species 18 preventing staining and discoloration of label face 10 and preventing degradation of the adhesive bond between the adhesive 14 and the label face 10.

FIG. 2 is a cross-section of tire film label with integrated barrier for use with an RFID tag. The label has a layered construction of a RFID tag support or base substrate 20 laminated to a barrier film 22. Typically, the RF tag support or base substrate 20 is not impermeable to migratory species. For example, the substrate 20 could be a polypropylene, polyolefin or other known film such as BOPP or EPDM co-polymers or blends. Preferably, the barrier film 22 is a polyester. Most preferably, the barrier film 22 is PET. Laminated to the barrier film 22 is adhesive 24. Preferably, the adhesive 24 is a pressure sensitive rubber adhesive. The RF tag comprises a RF tag support or base substrate 20, antenna 30 pressure sensitive, and integrated chip 32. The barrier film prevents diffusion of migratory components 18 from the tire surface 16 from interfering with the bonds between the RFID tag elements 30, 32. Without the barrier film 22, the RFID tag 30, 32 could be compromised. For example, bond between antenna 30 and base 20 could be compromised; bond between integrated chip 32 and base 20 could be compromised; and/or bond between antenna 30 and integrated chip 32 could be compromised.

The label may be made in linered and/or linerless embodiments. In linered embodiments the release liner is preferably a super calendared densified Kraft with a basis weight between 30 to 60 lbs. per 3,000 sq. ft. and a thickness of between 0.002 and 0.004 inches. A side of the release liner contacting the adhesive is coated with a release layer, for example, a cured silicone. The other side of the release layer may be coated with a similar release layer to prevent blocking (sticking) of the roll wraps if there is adhesive bleed around the edges of the die cut labels.

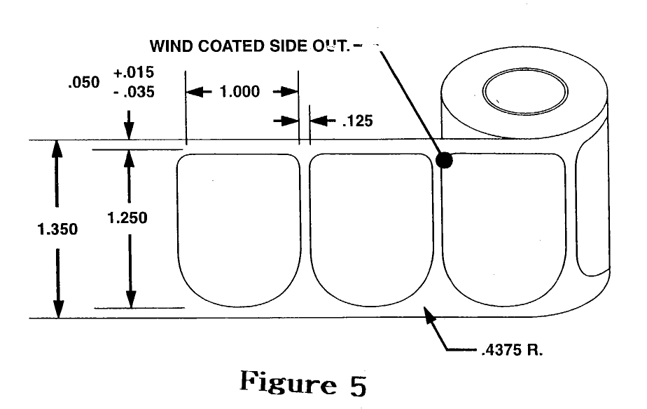

As shown in FIG. 5, the rolls of label media may be laid out for minimum waste and die cut for easy separation of the printed label.

The label may be printed using, for example, thermal transfer ribbon material using a resin based carbon black ink. To maximize protection of the printed label, a clear protective over laminate film or overprint varnish may be used to resist abrasion of the label printed indicia.

The present invention is entitled to a range of equivalents as to be limited only by the scope of the following claims.

1. A removable tire side wall label, comprising:
a label face stock having a film stiffness of between 20 to 80 mg (Gurly), and a thickness of between 0.001 and 0.008 inches;
the label face stock coated on a first side with a pressure sensitive rubber based adhesive having a thickness of between 0.001 and 0.004 inches.

2. The label of claim 1, further including:
a barrier coating between the label face stock and the adhesive.

3. The label of claim 2 wherein the barrier coating is comprised of a polyester film.

4. The label of claim 2 wherein the barrier coating is comprised of PET.

5. The label of claim 3 wherein the barrier coating has a thickness of about 3 microns to about 15 microns.

6. The label of claim 2 wherein the barrier coating inhibits migration of mobile subtances from an object and/or from the adhesive.

7. The label of claim 6 wherein the mobile substances are selected from the group consisting of oils, lubricants, plasticizers, resins, tackifiers, waxes and carbon black, aluminum compounds, sulfer compounds and combinations thereof.

8. A tire label comprising:
a label face stock;
an adhesive coated on a first surface of the label face stock; and
a barrier coating between the label face stock and the adhesive.

9. The label of claim 8 wherein the barrier coating is comprised of a polyester film.

10. The label of claim 8 wherein the barrier coating is comprised of PET.

11. The label of claim 10 wherein the barrier coating has a thickness of about 3 microns to about 15 microns.

12. The label of claim 8 wherein the barrier coating inhibits migration of mobile subtances from an object and/or from the adhesive.

13. The label of claim 12 wherein the mobile substances are selected from the group consisting of oils, lubricants, plasticizers, resins, tackifiers, waxes and carbon black, aluminum compounds, sulfer compounds and combinations thereof.

14. The label of claim 12 wherein the barrier coating is a material of dissimiliar polarity than the mobile substances and has a molecular structure that restricts migration of the mobile substances having a low molecular weight.

15. The label of claim 8 further comprising an RFID tag.

16. An RFID label for a tire comprising:
a base substrate;
an RFID tag on a first surface of the base substrate;
an adhesive coated on a second surface of the base substrate; and
a barrier coating between the base substrate and the adhesive.

17. The label of claim 16 wherein the barrier coating is comprised of a polyester film.

18. The label of claim 16 wherein the barrier coating is comprised of PET.

19. The label of claim 18 wherein the barrier coating has a thickness of about 3 microns to about 15 microns.

20. The RFID label of claim 16 further comprising a label face stock on the first surface, wherein the RFID is sandwiched between the label face stock and the base substrate.
